(19) United States
(12) Patent Application Publication
(10) Pub. No.: US 2014/0238309 A1
(43) Pub. Date: Aug. 28, 2014

(54) CAGING FOR SMALL ANIMALS

(71) Applicant: Brian Alan Hahn, Fairland, IN (US)

(72) Inventor: Brian Alan Hahn, Fairland, IN (US)

(21) Appl. No.: 13/775,604

(22) Filed: Feb. 25, 2013

(51) Int. Cl. A01K 1/03

(52) U.S. Cl. CPC A01K 1/03
USPC 119/472

(57) ABSTRACT

The present invention provides a cage which uses a removable tub having an interior wall which acts as a divider. The interior wall also provides a passageway, effectively placing the areas created by its presence into communication with each other. In the preferred embodiment, the location of the passageway prevents the easy movement of substrate and liquids between the separated areas.

### BACKGROUND OF THE INVENTION

1. Field of the Invention

This invention relates to small animal cages. More particularly, the present invention relates to vertically oriented caging for reptiles.

2. Description of the Prior Art

Cages are routinely used to house small animals. With the increased popularity of keeping pet reptiles, there has developed the need to provide caging which meets their specific environmental needs. Reptiles in general require an environment with temperatures and humidity levels greater than what would be comfortable for their human owners. Another requirement for many species is a hide spot, which may also be used as an egg laying chamber.

Reptile caging comes in many forms with some being more suitable than others. Some example caging styles include adapting a fish tank for use with reptiles by adding a specifically design lid and an artificial heat source, a purpose built vivarium such as the one described in U.S. Pat. No. 5,803,019 to Heilborn et al., and vertical caging systems which rely on removable/semi-removable tubs. Commercial breeders and some hobbyist typically prefer a variation of the vertical caging system because such systems minimize wasted space and provide for the efficient care and maintenance of the enclosed reptiles.

Numerous vertical caging systems, also referred to as “racks” or “rack systems”, are available on the commercial market. These caging systems rely on a removable tub consisting of a floor having connecting side walls. The lid of the tub enclosure is typically an integral portion of the support structure which receives the tub. The material and construction of these caging systems varies by manufacturer. Heating elements are typically attached to the supported structure and run underneath the tubs.

Reptiles in general and oviparous female reptiles in particular, require moderate to high levels of humidity. The high humidity aids reptiles with staying hydrated, shedding their epidermal layer and egg lying. Typically a substrate, such as sphagnum moss or cypress mulch for example, is placed within the animals hide to provide an area of elevated humidity which encourages egg lying. This substrate is often different from the substrate used in other portions of the cage.

Reptiles are shy animals, frequently requiring a hide spot to thrive and reproduce. As mentioned above, the hide spot often serves as a location for gravid females to deposit their eggs during the breeding season. Prior art rack system designs fail to provide a tub that provides a purpose built hide spot which is secured to the tub itself and instead rely on moveable hide boxes. These moveable hide boxes are typically not optimized for the tubs they are used in and thereby reduce the habitable space because they are not flush with the lid and side walls on the tub. Since they are not secured to the tub in any manner, the hide boxes are subject to being displaced by the animal. This can be problematic as it can lead to spilt water containers, displacement/destruction of eggs, disruption of any substrate placed under the hide box, and the creation of a generally non-aesthetically pleasing site.

Therefore in consideration of what is available in the prior art, it would be desirable to have a tub for a rack system which provides a hide spot that remedies the foregoing and other deficiencies inherent in the prior art.

### SUMMARY OF THE INVENTION

In view of the foregoing, one object of the present invention is to overcome the shortcomings in the design of vertical caging systems as described above.

Another object of the present invention is to provide a tub for a vertical caging system that has a hide spot for the animal(s) housed therein.

Yet another object of the present invention is to provide a tub in accordance with preceding objects which includes an interior wall, effectively dividing the interior area of the tub into two distinct compartments. A passage thru the wall is provided to facilitate movement between each compartment.

A further object of the present invention is to provide a tub in accordance with the preceding objects where the interior wall is fixedly secured to the tub, thereby preventing undesired displacement.

A still further object of the present invention is to provide a tub in accordance with the preceding objects which has a passage located on the interior wall. The location of the passage is selected to minimize the displacement of substrate and liquids between chambers.

In accordance with these and other objects, the present invention is directed to a tub having an interior wall which creates two chambers therein, one of these chamber's serves as a hide spot/egg laying spot for caged reptiles. The tub is designed to be used with vertical caging systems, and could be readily adapted to work with most designs.

The tub provided for herein includes a passageway thru the interior wall that places the two interior chambers into communication. The passageway is located in a corner of the interior wall, elevated off of the floor. The location of the passageway in the corner of the wall maximizes the area behind the wall where the animal may hide without being located directly behind the opening defining the passageway. By elevating the passageway opening, a separate substrate and/or additional liquid may be trapped within the hide spot chamber to raise the interior humidity.

In addition, the position of the passageway provides an elevated area from which a reptile emerging from its hide may lunge for its prey.

These together with other improvements and advantages which will become subsequently apparent reside in the details of construction and operation as more fully hereinafter described and claimed, reference being made to the accompanying drawings forming a part hereof, wherein like numerals refer to like parts throughout.

### BRIEF DESCRIPTION OF THE DRAWINGS

The novel features believed to be characteristic of the invention, together with further advantages thereof, will be better understood from the following description considered in connection with the accompanying drawings in which a preferred embodiment of the present invention is illustrated by way of example. It is to be expressly understood, however, that the drawings are for the purpose of illustration and description only and are not intended as a definition of the limits of the invention.

FIG. 1 is a perspective side view of a tub having an interior wall and a cup holder in accordance with the present invention.

FIG. 2 is a perspective side view of the tube shown in FIG. 1 rotated approximately 90 degrees.

FIG. 3 is a top view of the tub shown in FIG. 1.

FIG. 4 is a front view of the tub shown in FIG. 1.

FIG. 5 is a perspective view of a single level of the preferred embodiment vertical caging system.

FIG. 6 is a perspective view of the vertical caging system used with the tub 30 shown in FIG. 1, the indicated tub 30 is representative of all the undesignated tubs illustrated.

### DETAILED DESCRIPTION OF THE PREFERRED EMBODIMENT

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

The present invention is directed towards a tub that provides a hide spot, the tub being configured for use with a vertical caging system. As used herein, the phrases “vertical caging system”, “rack system”, or “racks” are used interchangeably.

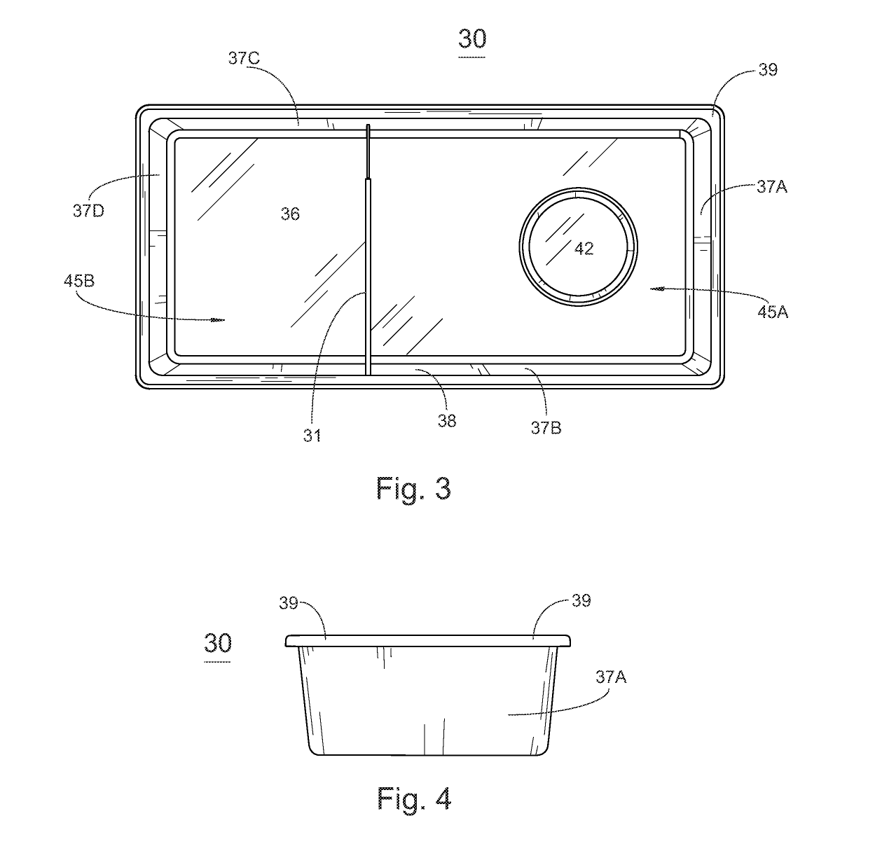

Turning now to the drawings in which like reference characters indicate corresponding elements throughout the several views, as used herein, the word “front” or “forward” corresponds to the end of the tub where the cup holder is located (i.e., to the right as shown in FIG. 3); “rear” or “rearward” or “back” corresponds to the direction opposite the end of the tub where the cup holder is located (i.e., to the left as shown in FIG. 3).

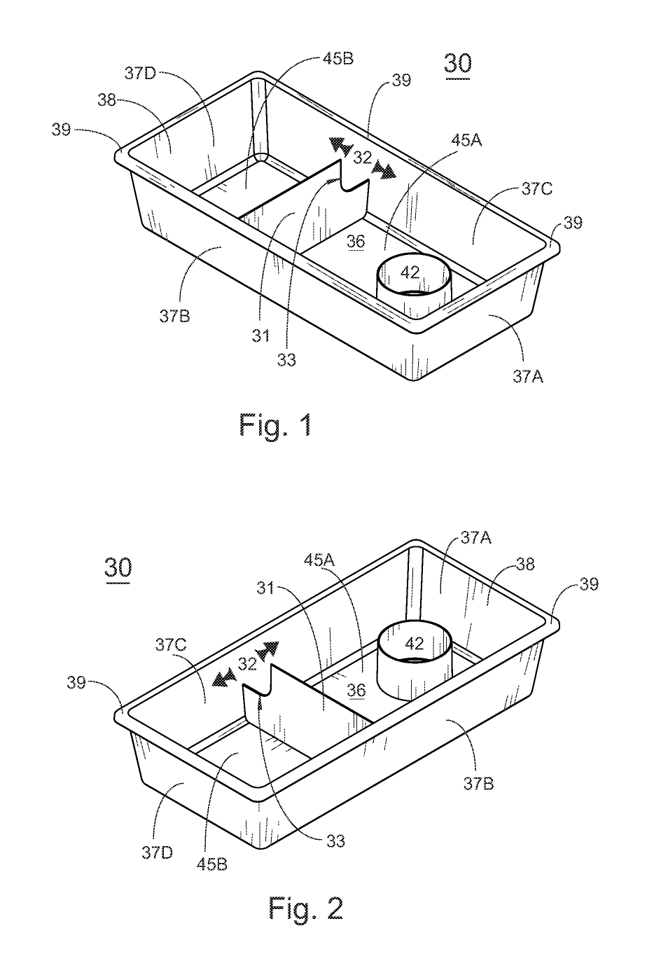

As shown in FIG. 1, the present invention is directed to a tub, generally designated by reference numeral 30, having an interior wall 31 with a passageway 32. It will be understood that the tub 30 is intended to be adapted and employed with any of the various rack systems available; however with minor modification, some of its features could be more widely used with other caging systems as well.

In FIGS. 1-4, the preferred embodiment of the tub 30 is shown. The tub 30 has a generally rectangular shape, being defined by a floor 36 and four connected side walls 37A, 37B, 37C, 37D, collectively referred to as side walls 38. An annular lip 39 is located about the top of the side walls 38 and extends around their entire perimeter, effectively defining the top surface of the tube 30.

An interior wall 31 is provided as an integral portion of the tub 30. The interior wall 31 extends between side walls 37C and 37B and is secured to the floor 36. Located thru one corner of the interior wall 31 is a passageway 32 defined by an opening 33 having the general shape of a rectangle. The interior wall 31 acts as a divider, effectively creating two compartments 45A and 45B within the tub 30. The passageway 32 places the two compartments 45A and 45B into communication with each other.

The size and/or shape of the opening 33 which defines the passageway 32 are selected based on the species of reptile to be housed therein. By elevating the opening 33 above the floor 36 of the tub 30, two different substrates may be used in each of the provided compartments 45A and 45B. Water may also be placed in one compartment without it leaking into the other. The location of the back compartment 45B is an optimal hide spot because it provides a secure dark location for the animal to dwell. By offsetting the passageway 32 opening 33 to one side of the interior wall 31, the animal has an appropriately sized compartment 45B in which to hide without being located directly behind the passageway 32.

Located in the front compartment 45A, there is an integrally formed cup holder 42. Deli cups are held within the cup holder 42 and are used to provide drinking water for the inhabitant. By using removable deli cups, it is easier to provide and maintain a source of potable drinking water. A cup holder could also be secured to the floor 36 of the tub 30 using an adhesive, or other means.

The tub 30, side walls 38, interior wall 31, floor 36, and cup holder 42 are unitarily constructed through an injection molding process using a polymer.

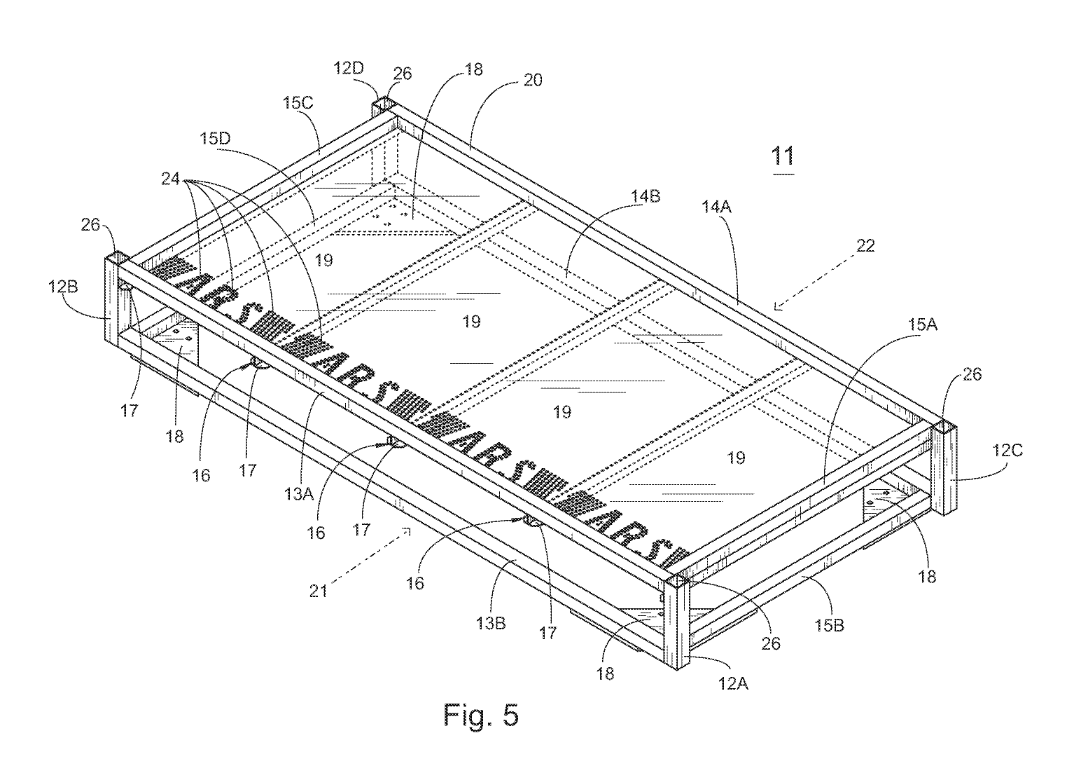

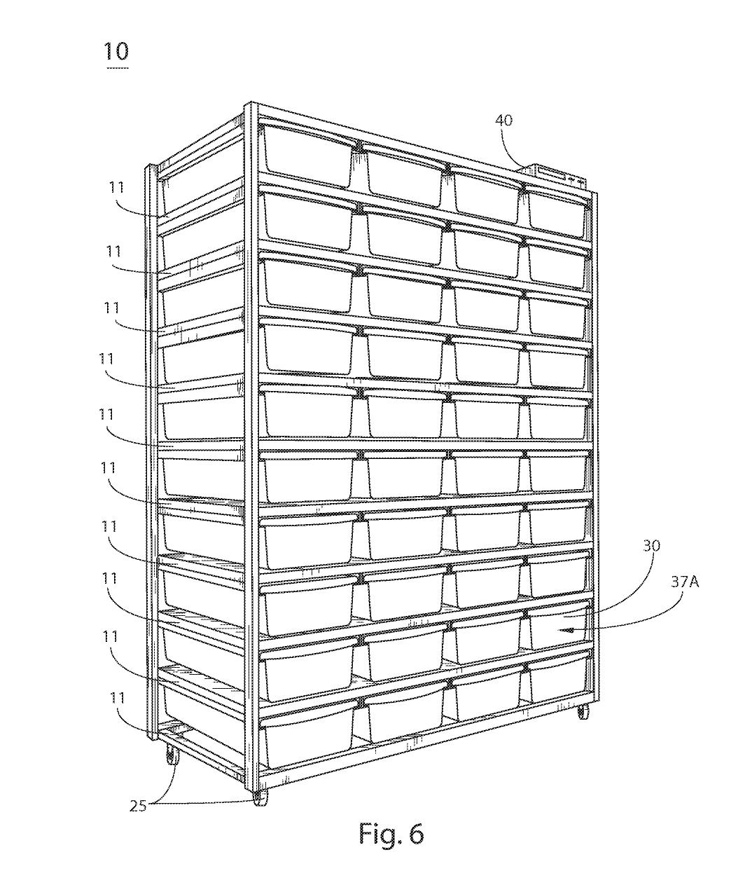

FIG. 5 shows, a single level 11 of the vertical caging system 10 shown in FIG. 6. Each level 11 provides a frame 20 to house four tubs 30. The frame 20 is constructed from four vertically oriented legs 12A, 12B, 12C and 12D, one being located at each corner of the frame 20. On the front side 21 of the frame 20 are two horizontally oriented tubes 13A and 13B that extend between legs 12A and 12B. Tube 13A is located above tube 13B. The two legs 12A and 12B on the front side 21 of the frame 20 are connected to the two vertically oriented legs 12C and 12D on the back side 22 of the frame 20, by a series of horizontally oriented side tubes 15A, 15B, 15C and 15D. Side tubes 15A and 15C are located above side tubes 15B and 15D, respectively. Side tubes 15A and 15B connect together legs 12A and 12C, while side tubes 15C and 15D connect together legs 12B and 12D.

Four top panels 19 are secured to each level 11 of frame 20. Each panel 19 is constructed to have a generally planar surface with two parallel, longitudinally extending channels 16 formed on each side. Each channel 16 defines an opening 17. The opening 17 of both channels 16 found on a single panel 19 face each other. There are also a series of vent holes 24 provided on the front portion of the panel 19 to allow for air exchange between the tub 30 and the outside environment (see FIG. 5). Location and the number of vent holes 24 varies based on the desired level of air exchange. This also serves as one way to regulate the humidity retained within. On the preferred embodiment panels 19, a portion of the vent holes 24 spell “ARS”.

The top panels 19 are secured to the underside of the frame 20 defined by tubes 14A, 13A, 15A and 15C. The channels 16 located on each panel 19 are configured to receive the annular lip 39 of a tub 30 found above side walls 37B and 37C. The number of panels 19 and correspondingly the number of tubs 30 provided for on each level 11 of caging may be altered without departing from the scope of the invention described herein.

Located on the bottom of the lowest level 11 are a series of plates 18, generally shaped like trapezoids, secured about each corner of the frame 20. The plates 18 provide a mounting point to which casters 25 may be secured. Casters 25 allow the cage to be moved around easily.

The vertically oriented legs 12A, 12B, 12C, 12D are configured to receive and be secured to the vertically oriented legs of another level 11 of frame 20. This is shown in FIG. 6, where ten levels 11 are secured together in a vertical orientation. In the preferred embodiment, the frame legs 12A, 12B, 12C, 12D for levels of framing located above the base level 11 shown in FIG. 5 each have an extension member (not shown) on their bottom side. The extension member is constructed to be received within the opening 26 present on the top side of each leg 12A, 12B, 12C, 12D. This allows the end user to build a rack system 10 which fits their needs.

Interior heat is provided to the tubs 30 by securing a heating panel (not shown) to the portion of the frame 20 located below each tub. The heating panels are generally located adjacent the back side 22 of the frame 20. The temperature of the tubs 30 is regulated through the use of a thermostat 40. Other heating elements and temperature regulators may be substituted and their location varied without departing from the scope of the invention disclosed herein.

Each level 11 of the vertical caging system 10 is assembled as described above. To secure the tub 30 to an assembled level 11 of caging, the tub 30 is oriented so that the portions of the annular lip 39 located above side walls 37B and 37C may be received within the openings 17 of the channels 16 provided on a single panel 19. The tubs 30 are designed to be slid in an out to facilitate interaction between the keeper and the animal occupant of the tub 30. The top panel 19 provided on each level of caging acts as a lid for the tub 30 secured to the channels 16 provided thereon, thereby preventing the escape of the animal occupant. Succinctly put, each level 11 of the vertical caging system 10 acts as a chassis that is configured to receive the tub 30 disclosed herein.

In an alternate embodiment, the tub 30 could be constructed without a cup holder 42.

In still another alternate embodiment, the tub 30 could be constructed without a unitary interior wall 31. Instead, the tub 30 could be modified to provide groove joints on the interior of its side walls configured to receive a removable wall segment.

In still yet another alternate embodiment, a unitarily constructed top panel could be constructed. Such a design could provide a single unitary planar surface that has a series of channels 16 attached and spaced at appropriate intervals along its surface configured to receive appropriately sized tubs 30.

In a further embodiment, a half wall could be used in place of the passageway 32 provided by the preferred embodiment.

In a still further embodiment, the location of the opening 17 which defines the passageway 32 may be changed based on the perceived needs of the animal to be housed therein or the personal preference of the manufacturer.

The foregoing descriptions and drawings should be considered as illustrative only of the principles of the invention. This invention is not limited for use with reptiles only; rather it may be used with any animal having similar environmental needs. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A tub for use with a caging system comprising a tub having four side walls, a bottom and an interior wall, said interior wall extending between two of said four side walls thereby creating two interior compartments, said interior wall defining an opening along its length configured to allow movement between said two interior compartments, the caging system being configured to removably receive and provide a ceiling for said tub, the ceiling acting as a lid to prevent the escape of an animal occupant.

2. The tub for use with a caging system of claim 1, said caging system is further comprised of at least two channels configured to receive a portion of said tub therein, said channels providing a surface on which said tub may be removably retained.

3. The tub for use with a caging system of claim 2, wherein said at least two channels run parallel to each other, said portion of said tub received by said channels is a projection which extends away from the interior of said tub.

4. The tube for use with a caging system of claim 3, wherein said projection occupies a plane which runs approximately perpendicular to a plane defined by the side wall from which it extends.

5. The tub for use with a caging system of claim 1, wherein said opening on said interior wall has the general shape of a rectangle, said opening being offset to one side of said interior wall's expanse.

6. The tub for use with a caging system of claim 5, wherein a bottom portion of said opening is elevated above said bottom of said tub.

7. The tub for use with a caging system of claim 6, wherein said interior wall is integrally formed as part of said tub.

8. The tub for use with a caging system of claim 1, wherein said bottom includes a receptacle thereon have a generally cylindrically shaped exterior surface.

9. A housing system for small animals comprising:
at least one enclosure defined by a floor and four exterior side walls, an interior wall which extends between two of said four exterior side walls is provided for, said interior wall creating two distinct compartments within said enclosure, said interior wall defining a thru bore thereon effectively placing each of said at least two chambers into communication with each other;
at least one chassis configured to removably receive said at least one enclosure, said at least one chassis is constructed to provide a generally planar surface which acts as a lid for said at least one enclosure when said at least one enclosure is secured therein.

10. The housing system as set forth in claim 9, wherein said interior wall is integrally formed as part of said at least one enclosure.

11. The housing system as set forth in claim 9, wherein said passageway is offset to one side of said interior wall.

12. The housing system as set forth in claim 11, wherein said passageway is elevated above said floor, thereby preventing the migration of substrate between said compartments.

13. The housing system as set forth in claim 12, wherein said planar surface of said at least one chassis is constructed with a plurality of vent holes therethrough to facilitate air exchange between said compartments of said at least one enclosure and the external environment.

14. The housing system as set forth in claim 9, wherein said at least one enclosure defines a lip about a top surface of said four exterior side walls, said lip extends outwardly away from the interior portion of said at least one enclosure, said chassis provides two channels thereon configured to slidably receive a portion of said lip found on two side walls located on opposite sides of said floor.

15. The housing system as set forth in claim 9, wherein said floor provides a receptacle thereon have a generally cylindrically shaped exterior surface.
